(19) United States
(12) Patent Application Publication
(10) Pub. No.: US 2008/0262841 A1
(43) Pub. Date: Oct. 23, 2008

(54) APPARATUS AND METHOD FOR RENDERING CONTENTS, CONTAINING SOUND DATA, MOVING IMAGE DATA AND STATIC IMAGE DATA, HARMLESS

(75) Inventors: Kohtaroh Miyamoto, Tokyo (JP); Yohei Ikawa, Kanagawa-ken (JP)

Correspondence Address: SHIMOKAJI & ASSOCIATES, P.C., 8911 RESEARCH DRIVE, IRVINE, CA, 92618, US

(73) Assignee: International Business Machines Corporation, Armonk, NY (US)

(21) Appl. No.: 11/871,331

(22) Filed: Oct. 12, 2007

(30) Foreign Application Priority Data
Oct. 13, 2006 (JP) 2006-280623

(51) Int. Cl. G10L 15/00; H04N 5/91

(52) U.S. Cl. 704/251; 386/66; 704/E15.001; 386/E05.001

(57) ABSTRACT

A method of rendering multimedia contents harmless is described. The method includes: reading out a predetermined word and the contents from a recording apparatus; replacing the predetermined word in transcript data with a different word, and setting the transcript data including the different word, and the predetermined word, respectively, as transcript data of harmless contents, and as transcript data of unique information; replacing the predetermined word with the different word, and setting the sound data including the different word and the predetermined word according to a time when the predetermined word appears in the firstly mentioned transcript data, respectively, as sound data of the harmless contents, and as sound data of the unique information; replacing the predetermined word in the presentation data with the different word, and the predetermined word, respectively, as presentation data of the harmless contents, and as presentation data of the unique information; recording the harmless contents; and recording the unique information.

### BACKGROUND OF THE INVENTION

The present invention relates to a technique for rendering contents containing sound data, moving image data and still picture data harmless and editing them.

In recent years, it has become easy to produce contents in which sound, moving images, captions, presentation pictures and the like are synchronized with one another (hereinafter, referred to as multimedia contents), and such contents have come to be used widely in areas such as study materials for e-Learning, and archiving of a lecture contents. On the other hand, under a current situation where the necessity of personal information protection as well as the importance of security have been increased, confidential information, privacy information, problematic remarks, and information (hereinafter, referred to as unique information) allowing one to analogically know such confidential or privacy information and the like are required to be prevented from being carelessly leaked from multimedia contents which have been instantly produced. The unique information has a risk of being leaked not only from sound and captions, but also from moving images, since it is not rare that moving images of a presentation are distributed together with other multimedia contents. The risk is especially high in a case where the moving images include such unique information. In addition, in a case of moving images of a face, contents of a speech are likely to be read from the moving images through lip reading.

As a method of preventing the unique information from being leaked, sanitization is performed. Sanitization is performed in order to safely disclose information, and is a process of rendering information harmless by removing confidential information; privacy information such as personal information; information containing problematic remarks regarding a particular gender, ethnic group, race and religion; and information (unique information) allowing such information to be analogically known. In the sanitization of text data, a problematic part such as a company secret, i.e., a piece of the unique information in the text is replaced with another term (a replacement term). For this purpose, the text is checked first by using a checker for the sanitization, and the sanitization is completed by having a replacement term or a deletion selected for the problematic part by using the check result. Examples of the sanitization include replacement of a proper noun such as “IBM Japan” with “a certain company,” and replacement of a telephone number “81-3-3586-1111” with “****.”

In sanitization processing in multimedia contents, confirmation of the unique information is carried out manually in the majority of cases. Because multimedia contents have sound, presentation pictures and moving images flowing in parallel with one another, checking work thereof has not been easy, and information is likely to be leaked due to a human error. In addition, in order to delete the unique information, it is necessary that the unique information be deleted from captions, be deleted from sound, be deleted also from presentation pictures, and be deleted from moving images. Because those different media require different tools and methods for the deletion, deleting work requires an immense amount of time and labor. Furthermore, it is required that data of the sound, presentation images and moving images after deleting work be integrated again as a single set of multimedia contents. Conventionally, it has been often the case that contents should be retaken in order to avoid such time and labor. However, a presenter and an editor are generally different in many cases, and it is difficult in some cases to set up a retake date by arranging their schedules. In such cases, contents obtained with some effort sometimes cannot be disclosed and must be discarded as they are.

Additionally, in focusing attention on authorization levels of end users who view multimedia contents, “need-to-know” levels are not the same even among company members of the same company, and depend on positions or departments to which company members belong. This is because different levels of authorization are given to different positions such as a president, board members, managers, and employees, and to different departments. For example, there is a case where, even in the same company, only board members are allowed to view account settlement information, mergers and acquisition information, information on announcement of a large-scale product, and the like. Furthermore, as employment statuses become more multifaceted in recent years, authorization levels given not only to company members but also to temporary staff, commission-based staff, part-timers, and the like have to be considered. However, in order to deliver the multimedia contents in accordance with authorization levels of users in the conventional method, it is required that varieties of the multimedia contents, the number of which agrees with the number of authorization levels, should be prepared in advance. Such a method has problems that: a size of varieties of multimedia contents including moving images and sound becomes larger as the number of variety combinations increases; and that production of the varieties of contents requires an enormous labor cost.

“Japanese Patent Translation Publication No. 2005-509953” discloses a method for constructing information specific to a receiver in a manner allowing each of information objects to be deleted and corrected in compliance with rules, and then to be delivered to an output stream, but does not specifically describe how to render harmful contents harmless.

### SUMMARY OF THE INVENTION

Objects of the present invention is to reduce a load involved in sanitization work of multimedia contents, and additionally, to dynamically produce multimedia contents in accordance with authorization levels of users.

In order to solve the abovementioned problems, disclosed in the present invention is a method of rendering contents harmless, the contents having transcript data and sound data synchronized with each other by time. The method includes the steps of: reading out a predetermined word from a recording apparatus; reading out the contents from a recording apparatus; judging whether the transcript data contains the predetermined word; replacing the predetermined word in the transcript data with a different word, and setting the transcript data including the different word, and the predetermined word, respectively, as transcript data of harmless contents, and as transcript data of unique information, on condition that it has been judged that the transcript data contains the predetermined word, replacing, according to a time when the predetermined word appears in the transcript data, the predetermined word in the sound data with the different word, and setting the sound data including the different word, and the predetermined word, respectively, as sound data of the harmless contents, and as sound data of the unique information, on condition that it has been judged that the transcript data contains the predetermined word, recording the harmless contents; and recording the unique information. Furthermore, in contents containing moving images, data of the images is filtered according to the time when the predetermined word appears in the transcript data. The method facilitates sanitization processing of multimedia contents.

### BRIEF DESCRIPTION OF THE DRAWINGS

For a more complete understanding of the present invention and the advantage thereof, reference is now made to the following description taken in conjunction with the accompanying drawings.

FIG. 1 exemplifies an apparatus for rendering contents harmless, and/or providing to users the contents having been rendered harmless.

FIG. 2 shows a display example of multimedia contents.

FIG. 3 exemplifies an outline of a functional configuration of an apparatus for rendering contents harmless.

FIG. 4 exemplifies an apparatus for reproducing multimedia contents from harmless contents and unique information, and providing the multimedia contents to users.

FIG. 5 exemplifies a processing flow for rendering contents harmless.

FIG. 6 exemplifies a processing flow for reproducing multimedia contents from harmless contents and unique information.

FIG. 7 exemplifies a basic structure of sound data (a sound file).

FIG. 8 shows an example of contents of contents data on which sanitization processing has been performed.

FIG. 9 exemplifies moving image data.

### DETAILED DESCRIPTION OF THE PREFERRED EMBODIMENT

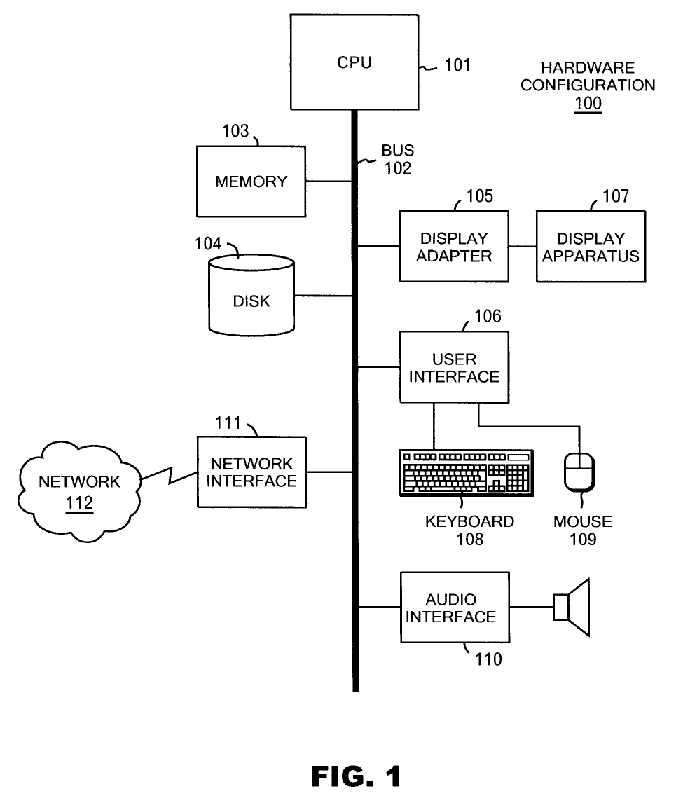

FIG. 1 exemplifies an outline of a hardware configuration 100 with respect to an apparatus for rendering contents harmless, and/or providing to users the contents having been rendered harmless. A CPU 101 which is a central processing unit executes various programs under control of operating systems of various kinds. The CPU 101 is mutually connected with a memory 103, a disk 104, a display adapter 105, and a user interface 106 through a bus 102.

The disk 104 contains: software and operating systems necessary for enabling a computer to function; programs for executing the present invention; and the like. As need arises, these programs are read out into a memory to be executed by CPU. Additionally, multimedia contents before sanitization, multimedia contents after sanitization, and among others, rules for sanitization are recorded in the disk 104. Note that the disk 104 is substitutable by a flush memory and the like, and it is self-evident to those skilled in the art that the disk 104 is not limited to a hard disk as long as it is a recordable medium such as a memory device.

A display apparatus 107 is connected to the bus 102 through the display adaptor 105. On the display apparatus 107, multimedia contents are displayed. Additionally, a graphical user interface for being operated when the present invention is executed may be displayed thereon. A keyboard 108 and a mouse 109 are connected to the bus 102 through the user interface 106. A user inputs, by use of the keyboard 108 and the mouse 109, information necessary for execution of the present invention and for other controls. An audio interface 110 is an interface used for reproducing sound data of multimedia contents, and a speaker and earphones are connected to the audio interface 110. Additionally, the hardware structure 100 is connected to a network 112 through a network interface 111.

In some cases, the present invention may be implemented in a distributed environment through the network 112. Note that this hardware configuration 100 is merely an exemplification of one embodiment for a computer system, bus arrangement and network connection, and that characteristics of the present invention can be realized in any one of various system configurations, and in a configuration having a plurality of identical constituent elements or in a configuration where constituent elements are distributed over a network.

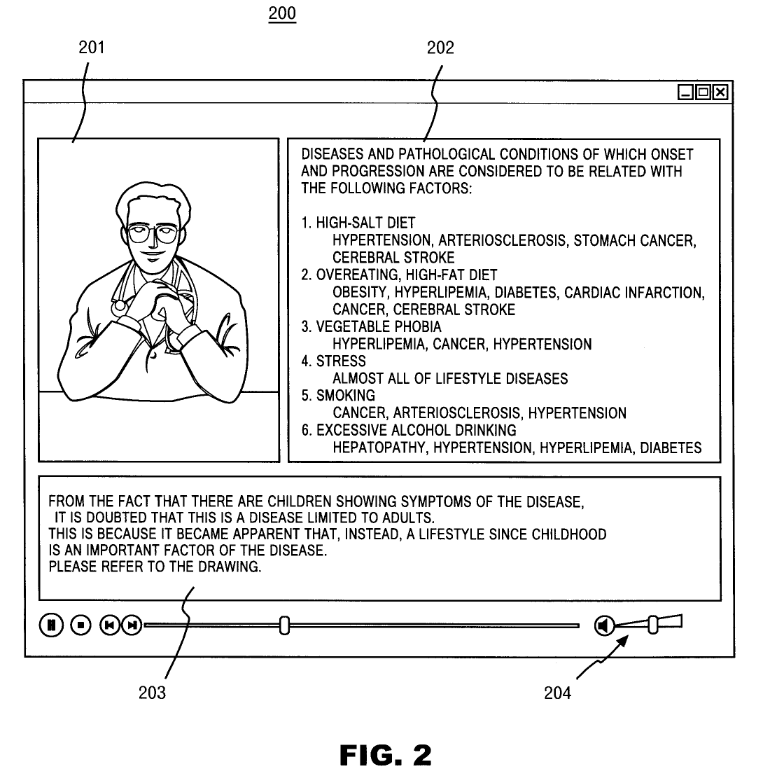

FIG. 2 shows a display example of multimedia contents 200. The multimedia contents contain moving image data 201, presentation image data 202, transcript data 203, and sound data. The moving image data 201 contains moving images where a presenter of a presentation speaks about contents of the presentation. In the presentation image data 202, a slide or a drawing, which is related to contents being spoken about by the presenter in the moving images, is displayed. The transcript data 203 is obtained by generating captions, through transcription or the like, from speech made by the presenter of the presentation. The transcript data 203 may be obtained by outputting the speech as text by a speech recognition technique. Although the sound data cannot be expressed here, a volume and the like thereof are adjusted by a GUI operation lever 204 and the like.

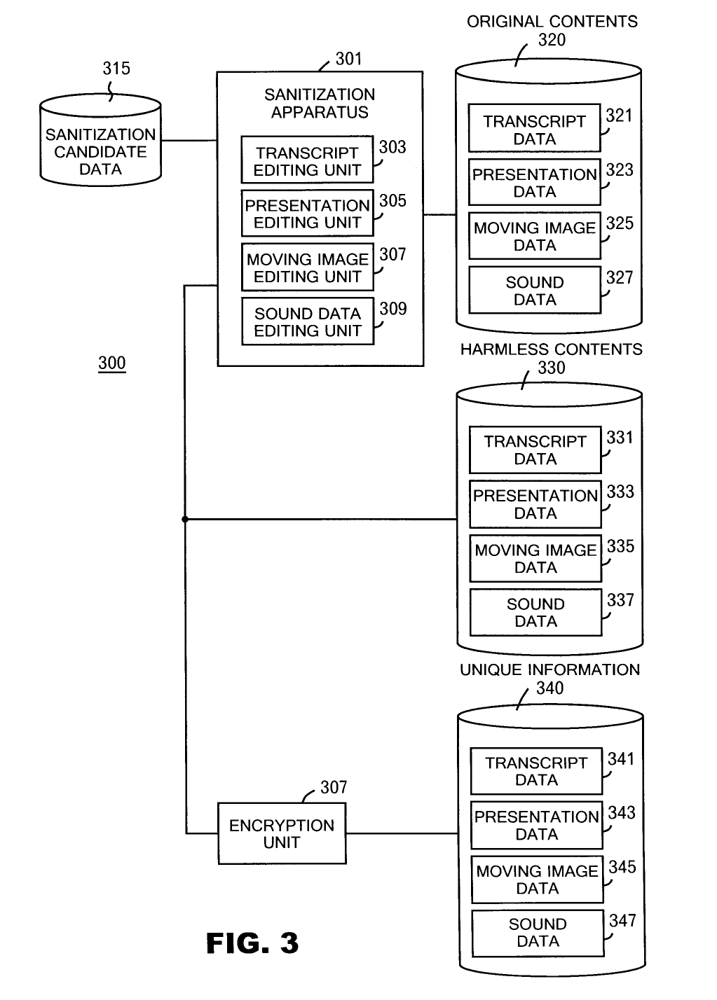

FIG. 3 exemplifies an outline of a functional configuration of an apparatus 300 for rendering contents harmless. A sanitization apparatus 301 performs sanitization processing on original contents 320 with reference to words which are candidates for sanitization, and also with respect to predetermined rules. The sanitization apparatus 301 includes: a transcript editing unit 303 for editing transcript data; a presentation editing unit 305 for editing presentation data; and a moving image editing unit 307 for editing and processing moving image data; and a sound data editing unit 309 for editing sound data.

The original contents 320 are multimedia contents, and contain transcript data 321, presentation data 323, moving image data 325 and sound data 327. Predetermined words that should be sanitized, or predetermined rules (logics) are recorded in sanitization candidate data 315, and original contents are sanitized by the sanitization apparatus 301 in a manner that the predetermined words, character strings or the like complying with the predetermined rules are extracted from the original contents. Here, the predetermined words mean terms such as discriminatory terms, and defaming terms against others, and are specific words that should be sanitized. Additionally, the predetermined rules mean for example, a rule by which character strings each being a numeric character string and having a hyphen in a predetermined position are specified in order to sanitize telephone numbers. The transcript editing unit 303 searches the transcript data 321 for the words that should be sanitized, or for character strings complying with the predetermined rules. Then, when any one of the words or any one of the character strings has been found, the transcript editing unit 303 deletes it, or replaces it with a different word. The transcript editing unit 303 sets, as transcript data of harmless contents, the transcript data after the deletion or the replacement, and also sets, as transcript data of unique information, original parts of the transcript data having been thus replaced, or deleted.

The presentation editing unit 305 searches the presentation data 323 for the words that should be sanitized, or for character strings complying with the predetermined rules. Then, when any one of the words and the character strings has been found, the presentation editing unit 305 deletes it, or replaces it with a different word. The presentation editing unit 305 sets, as presentation data of the harmless contents, the presentation data after the deletion or the replacement, and also sets, as presentation data of the unique information, original parts of the presentation data having been thus replaced, or deleted. Additionally, judgment on whether each of the words and character strings that should be sanitized is deleted or replaced from the contents can be implemented by having the judgment set up in the sanitization candidate data 315 in advance.

When any one of the words that should be edited (including the character strings complying with the predetermined rules) has been found in the transcript data 321, the moving image editing unit 307 performs filtering processing in response to timestamps of that word, the filtering processing being reduction of the number of frames of moving image data where a face of a presenter is displayed, reduction of the number of pixels thereof, or the like. This is performed for the purpose of making it impossible for a user to determine, according to movements of lips of the presenter, words uttered by the presenter. Additionally, the moving image editing unit 307 deletes or replaces information on a new product before being announced. The moving image editing unit 307 sets, as moving image data of the harmless contents, the moving image data after the deletion, the replacement or the filtering, and also sets, as transcript data of the unique information, original parts of moving image data having been replaced, deleted or filtered out. The presentation editing unit 305 also has the function of deleting, from the presentation data, an image of a new product before being announced. Note that the sanitization candidate data 315 may be configured to have information on images related to confidential information.

When any one of the words that should be sanitized has been found in the transcript data 321, the sound data editing unit 309 performs processing of deleting it or replacing it with a different word in response to timestamps for when that word appears. When performing the processing of replacing it with a different word, the sound editing unit 309 may be configured to use synthesized speech having similar voice sound as the sound data 327. The sound data editing unit 309 sets, as sound data of the harmless contents, the sound data after the deletion, or the replacement, and also sets, as sound data of the unique information, original parts of sound data having been thus replaced, or deleted.

Note that, when the transcript editing unit 303 performs the deletion on the transcript data, there may be a case where, in order to keep continuity of sentences natural, a whole sentence containing the word that should be sanitized is deleted from the transcript data. In such a case, the moving image editing unit 307 and the sound data editing unit 309 come to perform deletion on the moving images and the sound data, respectively, in response to a timestamp of the whole sentence.

Additionally, when the presentation editing unit 305 other way round deletes information on a new product before being announced, or the like, from the image data, corresponding data is deleted from the transcript data and the sound data in response to a timestamp of the deleted part of the image data. At that time, by recognizing breaks in text, deletion has to be performed on the transcript data, the moving image data and the sound data so that each of those data can be continued naturally.

In harmless contents 330, multimedia contents rendered harmless by deletion and replacement performed by the sanitization apparatus 301 are stored. The multimedia contents include multimedia contents formed of transcript data 331, presentation data 333, moving image data 335, and the sound data 337. Multimedia contents corresponding to only parts that should be sanitized are saved in unique information 340. The words that should be sanitized, or data of whole sentences each including any one of the words, are saved in transcript data 341.

The words each of which should be deleted or replaced are saved, in association with information on display positions of the words, in presentation data 343. Data having been filtered out, deleted data of a new product before being announced, and the like, are saved in moving image data 345. Sound data 347 contains sound data having been deleted. An encryption unit 370 is used for encrypting unique information because the unique information may possibly have confidential information. Note that the unique information 340 can be configured to hold information on authorization levels, compare the authorization levels against users trying to access contents, and enable accesses only from users who satisfy conditions.

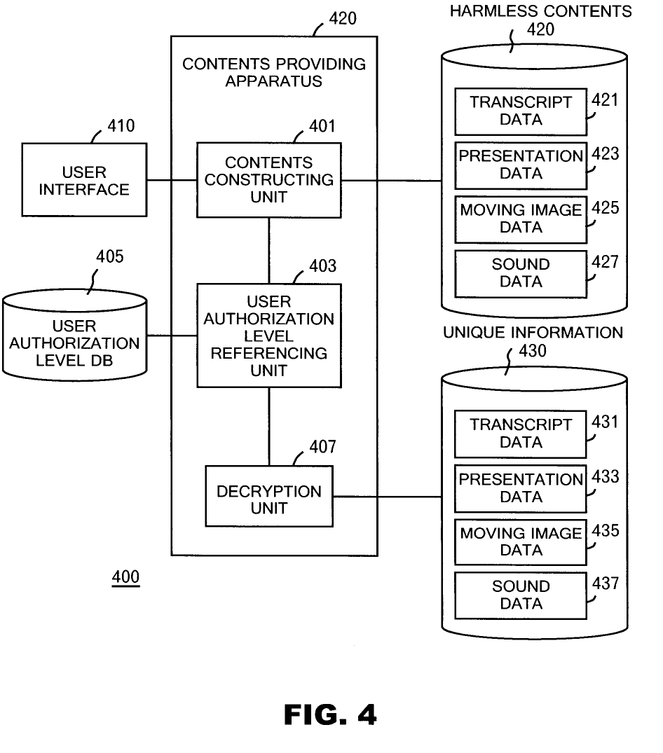

FIG. 4 exemplifies an apparatus 400 for reproducing multimedia contents from harmless contents and unique information, and providing the multimedia contents to users. A contents providing apparatus 402 includes a contents constructing unit 401, a user authorization level referencing unit 403, and a decryption unit 407. The contents constructing unit 401 has a function of combining harmless contents 420 and unique information 430, and thereby producing multimedia contents. A user interface 410 is used for providing the multimedia contents to users.

The harmless contents 420 and the unique information 430 are identical to the harmless information 330 and the unique information 340 in FIG. 3. The user authorization level referencing unit 403 compares with each other an access authorization level with respect to each user which has been stored in a user authorization level DB 405, and an authorization level of data read out from the unique information 430. Then, when the user has a right to access confidential information, data of the unique information is provided to the contents constructing unit. The decryption unit 407 has a function of decrypting unique information having been encrypted.

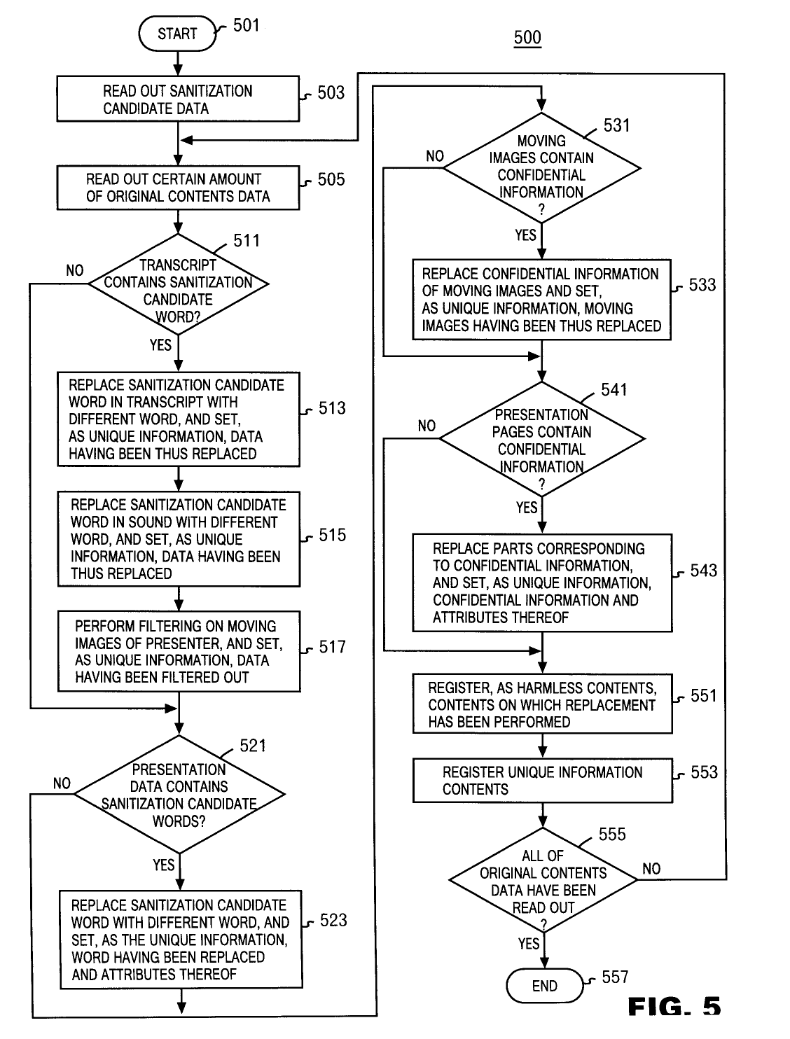

FIG. 5 exemplifies a processing flow 500 for rendering contents harmless. In step 501, the processing flow is started. In step 503, a certain amount of sanitization candidate data is read out. In step 511, whether or not transcript data in original contents data contains each of sanitization candidate words (including character strings complying with predetermined rules) is judged. If it has been judged that the transcript data contains any sanitization candidate word (Yes), the processing flow proceeds to step 513. In step 513, the sanitization candidate word is replaced with a different word, and the original contents including the different word are set as harmless contents. The word having been replaced is set, in association with timestamps specified as a time when the word appears in the original contents, as unique information.

In step 515, locations where the sanitization candidate word exists are specified according to the timestamps, these locations are replaced with synthesized speech in which a different word is uttered instead, and the original contents after the replacement is set as the harmless contents. The parts of the sound data which correspond to the word after the replacement are set as unique information. In step 517, in a case where a face of a presenter appears in moving images therein, filtering processing is performed on the moving images with respect to the timestamps, and the original contents on which the filtering processing has been performed is set as the harmless contents. Parts of the moving images having been thus filtered out are set as the unique information. Thereafter, the processing flow proceeds to step 521. The processing flow proceeds to step 521 if it has been judged in step 511 that the transcript data contains no sanitization candidate word (No).

In step 521, whether or not presentation data in the original contents data contains each of sanitization candidate words is judged. If it has been judged in step 521 that the presentation data contains any sanitization candidate word (Yes), the sanitization candidate word in the presentation data is replaced with a different word, and the presentation data including the different word is set as the harmless contents. Parts of the presentation data which have been replaced are set, in association with attributes of and positional information on the parts, as the unique information. Thereafter, the processing flow proceeds to step 531. The processing flow proceeds to step 531 if it has been judged in step 521 that the presentation data contains no sanitization candidate word (No).

In step 531, whether or not moving image data in the original contents data contains any confidential information is judged. Here, for example, whether or not an image picture of a new product before being announced is contained is judged by using an image recognition technique or the like. If it has been judged in step 531 that the moving image data contains any confidential information (Yes), parts of the moving image data which contain the confidential information are replaced, and the moving image data including the different word is set as the harmless contents. The parts of the moving image data which have been thus replaced are set as the unique information. Thereafter, the processing flow proceeds to step 541. The processing flow proceeds to step 541 if it has been judged in step 531 that the moving image data contains no confidential information (No).

In step 541, whether the presentation data contains any confidential information in the form of image is judged. This is performed for the purpose of checking whether or not a picture of a new product before being announced, or the like, appears in the presentation data. If it has been judged in step 541 that the presentation data contains any confidential information (Yes), the presentation data including the different word is set as the harmless contents in step 543. The parts corresponding to the images which have been thus replaced are set as the unique information. Thereafter, the processing flow proceeds to step 551. The processing flow proceeds to step 551 if it has been judged in step 541 that the presentation data contains no confidential information (No).

In step 551, the transcript data, the presentation data, the moving image data and the sound data which have been set as the sanitized harmless contents are recorded in a disk or the like. In step 553, the transcript data, the presentation data, the moving image data and the sound data which have been set as the unique information are recorded in a disk or the like. In step 555, whether all of the original contents data have been read out and processed is judged. If it has been judged in step 555 that all of the original contents data have been read out and processed (Yes), the processing flow proceeds to step 557, where the processing flow 500 is ended. If it has been judged in step 555 that not all of the original contents data have been read out and processed (No), the processing flow returns to step 505, where the processing of reading out the original contents data is performed.

Note that, in steps 511 to 517, the processing flow may be configured so that, after rendering the transcript data harmless by deleting the sanitization candidate word in the transcript data, deletion can be performed on the sound data and the moving image data in response to the deletion performed on the transcript data. In this case, multimedia contents after these deletions are set as the harmless contents, and deleted parts are set as the unique information. Additionally, in steps 531 to 543, the processing flow may be configured so that: according to a time when parts of the moving image data and the presentation data appear, multimedia contents can be rendered harmless by deleting, from the multimedia contents, data thereof appearing at those times, the parts containing confidential information; and the deleted data of the multimedia contents can be set as the unique information.

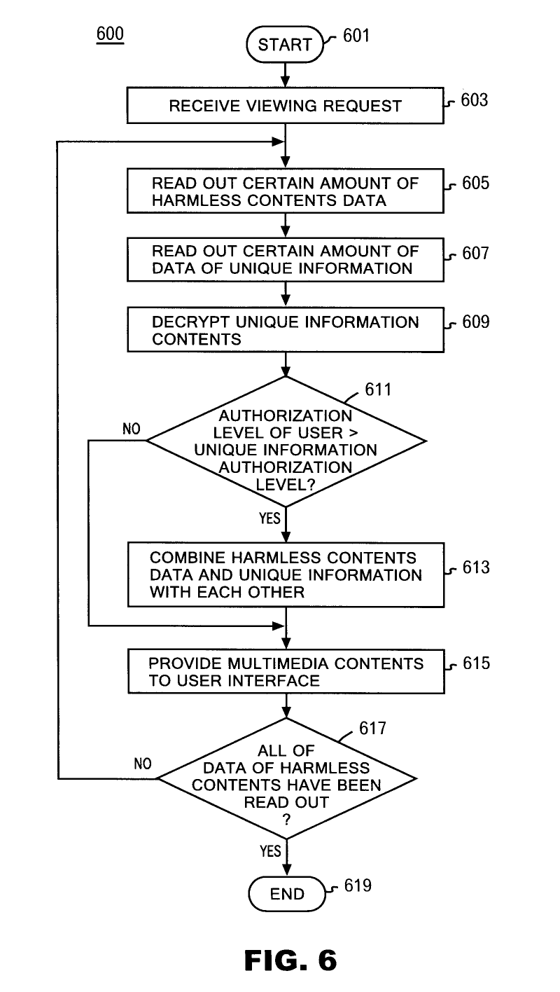

FIG. 6 exemplifies a processing flow 600 for reproducing multimedia contents from harmless contents and unique information. In step 601, the processing flow is started. In step 603, a viewing request from a user is received. Respectively in steps 605 and 607, a certain amount of data of harmless contents, and a certain amount of data of unique information are read out. In step 609, because the data of the unique information has been encrypted, the data is decrypted.

In step 611, it is judged whether an authorization level of the user who has issued the viewing request is higher than an access authorization level contained in the unique information. If it has been judged in step 611 that an authorization level of the user who has issued the viewing request is higher than an access authorization level contained in the unique information (Yes), the processing flow proceeds to step 613. In step 613, the data of the harmless contents, and the unique information, are combined with each other.

In this combining, parts of the data of the harmless contents are replaced with the unique information according to timestamps. If it has been judged in step 611 that an authorization level of the user who has issued the viewing request is not higher than an access authorization level contained in the unique information (No), the processing flow proceeds to step 615. In this case, eventually, information of the harmless contents only is provided without having the unique information contained in the multimedia contents. In step 617, whether all of the data of the harmless contents have been read out and processed is judged.

If it has been judged in step 617 that all of the harmless contents data have been read out and processed (Yes), the processing flow proceeds to step 619, where the processing flow 600 is ended. If it has been judged in step 617 that all of the harmless contents data have not yet been read out and processed (No), the processing flow returns to step 605, where the processing of reading out the harmless contents data is performed.

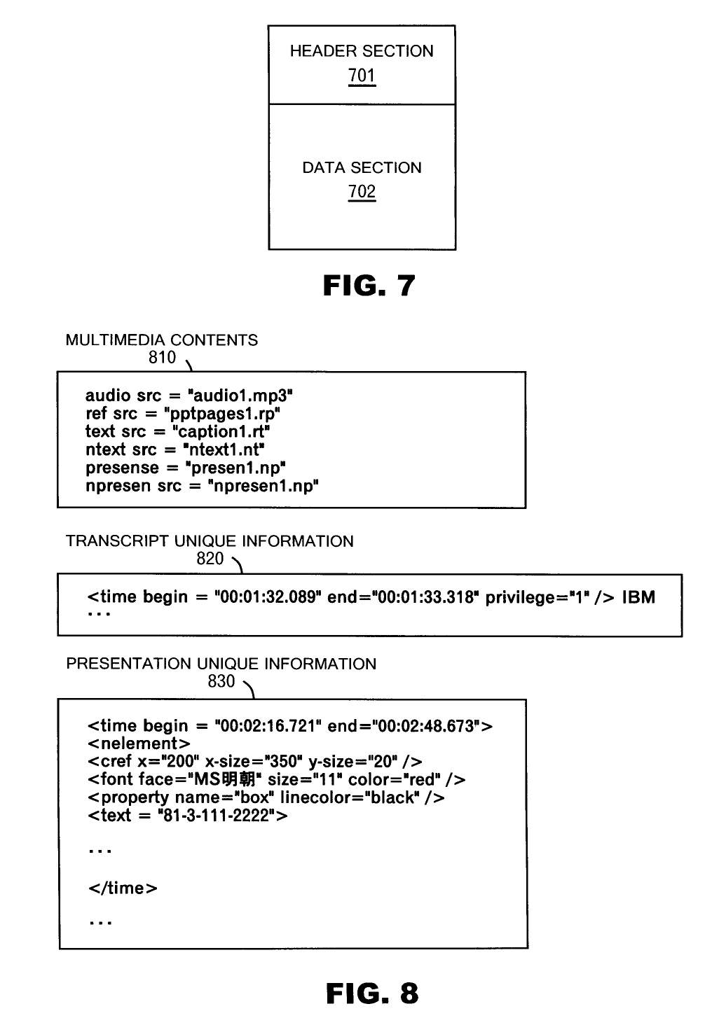

FIG. 7 exemplifies a basic structure of sound data (a sound file) 700. Examples of operations performed when the sound data is sanitized and when sound is reconstructed in accordance with an authorization level will be described. The sound data is basically composed of: a header section 701 in which a data structure is described in text; and a data section 702 in which binary data of sound is defined. In order to sanitize the sound data, processing is performed by the following procedure.

A time range (denoted as being from Ts to Te) that should be sanitized is acquired from applicable sanitized-transcript timestamps;

(2) information from the header section is read out, and an area from Ds to De in the data section corresponding to the time range Ts to Te are acquired;

(3) data in the area from Ds to De is securely stored in a unique information DB; and

(4) processing of muting the data in the range from Ds to De is performed. When the sound data is reconstructed in accordance with an authorization level, processing is performed by the following procedure.

An authorization level of a user is referred with respect to unique information in the range from Ts to Te. On conditions that the user does not have an authorization level allowing the user to appropriately view the unique information, and that a setting of sound for the unique information is muting, contents are replayed as they are; on the other hand, on conditions that the user does not have an authorization level allowing the user to view the unique information, and that the setting is other than muting, the data in the range from Ds to De is found from the header section as in the case with the sanitization processing, and appropriate processing (in accordance with the setting) is performed; and

finally, on condition that the user has an authorization level allowing the user to view the unique information, the range from Ds to De is found likewise, and the unique information in sound, which is securely taken out from the unique information DB, is written in this range (reconstructed).

Moving picture data (a moving image file) also includes a header section and a data section, and has a data structure similar to that of the sound data. For this reason, a drawing thereof is omitted. In order to sanitize the moving image data, the following processing is performed.

As in the case with the sound data, a time range (denoted as being from Ts to Te) that should be sanitized is acquired from applicable sanitized-transcript timestamps;

as in the case with the sound data, information from the header section is read out, and limits (addresses) Ds and De of a range in the data section respectively corresponding to Ts and Te are acquired; and

data in the range from Ds to De is securely stored in a unique information DB as in the case with the sound data, and processing of inserting an empty image into the range from Ds to De is performed.

When the moving image data is reconstructed other way round in accordance with an authorization level, the following processing is applied.

An authorization level of a user is referred with respect to unique information in the range from Ts to Te. On conditions that the user does not have an authorization level allowing the user to appropriately view the unique information, that moving images are moving images of a face, and that a setting of moving images for the unique information is “changing the number of frames of moving images of a face,” the moving data, which is securely taken out from the unique information DB, is inserted in the range from Ds to De after the number of frames thereof is reduced (or is reduced in a pseudo manner);

on the other hand, on conditions that the user does not have an authorization level allowing the user to view the unique information, and that the setting of moving images is “scene replacement,” an applicable range of scenes with respect to the range from Ts to Te is found from the header section, and processing of the scene replacement is performed; and

finally, on condition that the user has an authorization level allowing the user to view the unique information, the range from Ds to De is found likewise, and the unique information in moving images, which is securely taken out from the unique information DB, is written into this range (reconstructed).

FIG. 8 shows an example of contents of contents data on which the sanitization processing has been performed. Reference numeral 810 shows an example of contents of a file (contents1.smil1) of multimedia contents containing unique information. As a basic configuration thereof, file names of sound (audio), unique information (audio) of a sound part, images (ref), a transcript (text), unique information (ntext) of a transcript part, a presentation (presen), and unique information (npresen) of the presentation are defined respectively.

Reference numeral 820 shows an example of the unique information of the transcript part. As a basic configuration thereof, a starting time (begin), a termination time (end), access authorization levels (privilege), and unique information text (IBM) are included. In this example, it can be grasped that unique information which is “IBM” was uttered between 1 minute 32.089 seconds and 1 minute 33.089 seconds. Note that, when the unique information is a discriminatory term, it is preferable that the access authorization levels be configured so that no users can access the unique information.

Reference numeral 830 shows an example of the unique information of the presentation. Therein, with respect to each page unit (time) of the presentation, an element (nelement) of each piece of the unique information are defined. With respect to each of the elements, font information (font), an attribute (property) of the element, and text (text) are defined. As a piece of the unique information, there exists a telephone number “80-3-1111-2222.”

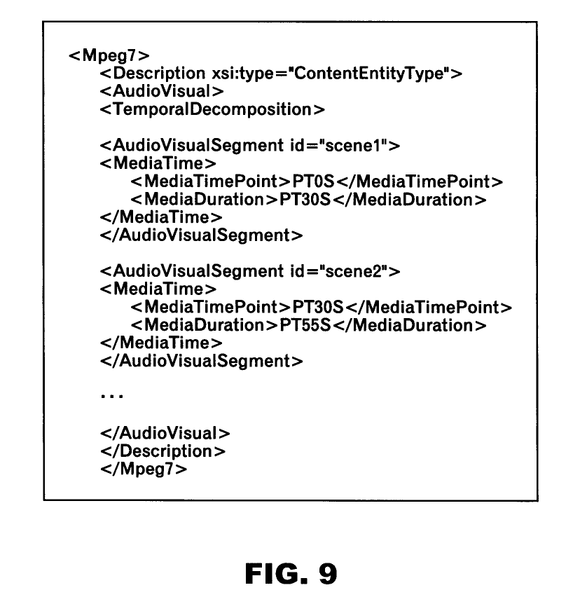

FIG. 9 exemplifies moving image data. A method of detecting a scene from moving images in Mpeg-7 will be briefly described. By looking specifically at tags, it can be known by “AudioVisual” that those are multimedia type contents. Each scene is defined by “AudioVisualSegment,” and is provided with a name by “id.” While a starting time of each scene is defined by “MediaTimePoint,” a duration of each scene is defined by “MediaDuration.” In this example, there are two scenes referred to as “scene 1” and “scene 2,” and durations of them are 30 seconds and 50 seconds, respectively. According to these pieces of information, if at least any one of the scenes contains any unique information, the scene containing unique information is supposed to be dynamically replaced. Note that, by using well known techniques of moving image data editing function, a problematic scene may be specified in a more detailed manner by further breaking down a scene, and plural scenes may be combined into one scene.

As has been described hereinabove, according to the present invention, multimedia contents data can be easily rendered harmless even when the data contains a discriminatory term or confidential information. Additionally, it becomes possible to provide harmless contents having been rendered harmless, and unique information containing confidential information or the like, in accordance with access authorization levels of users.

While the present invention has been described hereinabove by using the embodiment, a technical scope of the present invention is not limited to the scope described in the abovementioned embodiment. It is apparent to those skilled in the art that various modifications or improvements can be made to the above-mentioned embodiment. It is apparent from the scope of claims that embodiments to which such modifications or improvements have been made can also be included in the technical scope of the present invention.

1-17. (canceled)

18. A method of rendering contents, having transcript data and sound data synchronized with each other by time, harmless in a computer having a means for setting as transcript data of unique information, a means for setting as sound data of unique information, a storage device for recording harmless contents and a storage device for recording unique information, comprising the steps of:
reading out a predetermined word from a recording apparatus by the means for setting as transcript data of unique information;
reading out the contents from a recording apparatus by the means for setting as the transcript data of unique information;
judging whether or not the transcript data contains the predetermined word by the means for setting the transcript data of unique information;
replacing the predetermined word in the transcript data with a different word, and setting the transcript data including the different word and the predetermined word as a transcript data of harmless contents and as a transcript data of the unique information, respectively, on condition that it has been judged that the transcript data contains the predetermined word by the means for setting as the transcript data of the unique information;
replacing the predetermined word of a time stamp in the sound data with the different word based upon the time stamp where the predetermined word appears in the transcript data, and setting the sound data including the different word and the predetermined word as a sound data of harmless contents and as a sound data of the unique information, respectively, on condition that it has been judged that the transcript data contains the predetermined word;
recording the harmless contents in the storage device for recording the harmless contents; and
recording the unique information in the storage device for recording the unique information; wherein, the contents contain moving image data of a presenter, and
the method further comprises the steps of:
filtering a portion corresponding to a time stamp of the moving image data on the basis of the time stamp when a predetermined word appears in the transcript data, and setting the filtered portion as a picture data of harmless contents, on condition that it has been judged that the transcript data contains the predetermined word;
recording an image data of the harmless contents in the storage device for recording harmless contents; and
recording a portion of an original data before filtering the image data in the storage device for recording unique information as unique information.

19. The method according to claim 18, wherein the contents contains presentation data, and
the method further comprises the steps of:
determining whether or not the presentation data contains the predetermined word; and
replacing the predetermined word of the presentation data with a different word, and setting the presentation data including a different word and the predetermined word as the presentation data of harmless contents and as the presentation data of unique information, respectively, on condition that it has been judged that the presentation data contains the predetermined word.

20. The method according to claim 18, wherein the step of recording the unique information further comprises the step of registering authorization levels for accessing the unique information.

21. The method according to claim 18, wherein the step of recording the unique information further comprises the step of encrypting the unique information.

22. The method according to claim 20, further comprising the step of replacing the predetermined image with a different image, on condition that the presentation data contains a predetermined image.

23. The method according to claim 18, wherein, in the step of setting the predetermined word as sound data of the unique information, the predetermined word is replaced with the different word by using synthesized speech.
